(19) United States
(12) Patent Application Publication
(10) Pub. No.: US 2011/0175983 A1
(43) Pub. Date: Jul. 21, 2011

(54) APPARATUS AND METHOD FOR OBTAINING THREE-DIMENSIONAL (3D) IMAGE

(75) Inventors: Sung-Chan PARK, Suwon-si (KR); Won-Hee Choe, Seoul (KR); Byung-Kwan Park, Seoul (KR); Seong-Deok Lee, Seongnam-si (KR); Jae-Guyn Lim, Seongnam-si (KR)

(73) Assignee: SAMSUNG ELECTRONICS CO., LTD., Suwon-si (KR)

(21) Appl. No.: 13/006,676

(22) Filed: Jan. 14, 2011

(30) Foreign Application Priority Data
Jan. 15, 2010 (KR) 10-2010-0004057

(51) Int. Cl. H04N 15/00; G03B 35/08

(52) U.S. Cl. 348/46; 396/324; 348/E15.001

(57) ABSTRACT

An apparatus and method for obtaining a three-dimensional image. A first multi-view image may be generated using patterned light of infrared light, and a second multi-view image may be generated using non-patterned light of visible light. A first depth image may be obtained from the first multi-view image, and a second depth image may be obtained from the second multi-view image. Then, stereo matching may be performed on the first depth image and the second depth image to generate a final depth image.

### CROSS-REFERENCE TO RELATED APPLICATION(S)

This application claims the benefit under 35 U.S.C. §119(a) of a Korean Patent Application No. 10-2010-0004057, filed on Jan. 15, 2010, in the Korean Intellectual Property Office, the entire disclosure of which is incorporated herein by reference for all purposes.

### BACKGROUND

1. Field

The following description relates to a technology for obtaining a distance image and a three-dimensional (3D) image.

2. Description of the Related Art

One representative technique for obtaining information regarding a distance to an object is based on images is by using trigonometry. In trigonometry, at least two different images captured at different positions are used to calculate a distance to a photographed object. Trigonometry is based on a principle similar to the human visual system that allows us to estimate a distance of an object using both eyes, i.e., stereo vision. Trigonometry may be generally classified into active and passive types.

In active-type trigonometry, a particular pattern is projected onto an object and the pattern is taken as reference. Then, a comparatively accurate distance can be measured since distance information with respect to a reference pattern is previously provided. However, active type trigonometry is limited by the intensity of the pattern which is projected onto the object, and thus if the object is located far away, the pattern projection is degraded.

In passive-type trigonometry, information regarding an original texture of an object is taken as reference without using a particular pattern. Since the distance to an object is measured based on the texture information, accurate outline information of the object can be acquired, but passive type trigonometry is not suitable for application to a region of an object which has little texture.

### SUMMARY

In one general aspect, there is provided an apparatus for obtaining a three-dimensional image, the apparatus including: a first depth image obtaining unit configured to obtain a first depth image, based on patterned light, a second depth image obtaining unit configured to obtain a second depth image, based on non-patterned light that is different from the patterned light, and a third depth image obtaining unit configured to obtain a third depth image, based on the first depth image and the second depth image.

In the apparatus, the third depth image obtaining unit may be further configured to perform stereo matching on the first depth image and the second depth image to obtain the third depth image.

In the apparatus, the third depth image obtaining unit may be further configured to perform the stereo matching based on an energy-based Markov Random Field (MRF) model.

The apparatus may further include: a pattern projection unit configured to project the patterned light onto an object, and a camera unit configured to detect light reflected from the object.

In the apparatus, the pattern projection unit may be further configured to generate the patterned light using infrared light or ultraviolet light.

In the apparatus, the camera unit may include: a first sensor unit configured to detect infrared or ultraviolet light, corresponding to the patterned light from the object, and a second sensor unit configured to detect visible light corresponding to the non patterned light from the object.

The apparatus may further include a filter configured to divide reflective light based on a type of light to which the reflective light corresponds between the patterned light and the non-patterned light.

In another general aspect, there is provided a method of obtaining a three-dimensional image, the method including: obtaining a first depth image, based on patterned light, obtaining a second depth image, based on non-patterned light that is different from the patterned light, and obtaining a third depth image, based on the first depth image and the second depth image.

In the method, the obtaining of the third depth image may include performing stereo matching on the first depth image and the second depth image.

In the method, in the obtaining of the third depth image, the performing of the stereo matching may be based on an energy-based Markov Random Field (MRF) model.

In the method, the patterned light may be based on infrared light or ultraviolet light.

The method may further include dividing, with a filter, reflective light based on a type of light to which the reflective light corresponds between the patterned light and the non-patterned light.

In another general aspect, there is provided a computer-readable information storage medium storing a program for implementing a method of obtaining a three-dimensional image, including: obtaining a first depth image, based on patterned light, obtaining a second depth image, based on non-patterned light that is different from the patterned light, and obtaining a third depth image, based on the first depth image and the second depth image.

In the computer-readable information storage medium, the obtaining of the third depth image may include performing stereo matching on the first depth image and the second depth image.

In the computer-readable information storage medium, in the obtaining of the third depth image, the performing of the stereo matching may be based on an energy-based Markov Random Field (MRF) model.

In the computer-readable information storage medium, the patterned light may be based on infrared light or ultraviolet light.

The computer-readable information storage medium may further include dividing reflective light based on a type of light to which the reflective light corresponds between the patterned light and the non-patterned light.

Other features and aspects may be apparent from the following detailed description, the drawings, and the claims.

### BRIEF DESCRIPTION OF THE DRAWINGS

FIG. 1 is a diagram illustrating an example of a system of a three-dimensional (3D) image obtaining apparatus.

FIG. 2 is a view illustrating an example of a pattern projection unit.

FIGS. 3A to 3D are diagrams illustrating examples of a camera unit.

FIG. 4 is a diagram illustrating an example of an image signal processor (ISP).

FIG. 5 is a flowchart of an example of a method of obtaining a three-dimensional image.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

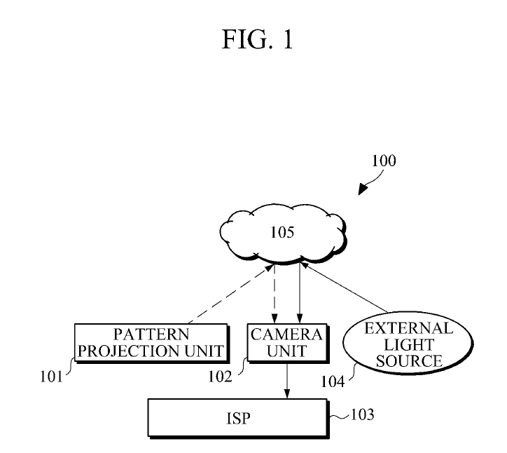

FIG. 1 illustrates an example of a system of a three-dimensional (3D) image obtaining apparatus. Referring to FIG. 1, the 3D image obtaining apparatus 100 may include a pattern projection unit 101, a camera unit 102, and an image signal processor (ISP) 103.

The pattern projection unit 101 and an external light source 104 may emit light towards an object 105. The camera unit 102 may detect light reflected from the object 105. The light detected by the camera unit 102 may be reflective light (for example, depicted by dotted lines in FIG. 1) from the pattern projection unit 101, or reflective light (for example, depicted by solid lines in FIG. 1) from the external light source 104.

The pattern projection unit 101 may project patterned light towards the object 105. In one example, the patterned light may be infrared light or ultraviolet light, which may have a random pattern. For example, the pattern projection unit 101 may use infrared light for the patterned light to be projected towards the object 105.

The external light source 104 may emit non-patterned light towards the object 105. The non-patterned light may be visible light which may have no pattern. For example, the external light source 104 may emit visible light towards the object 105.

The patterned light from the pattern projection unit 101 may be reflected from the object 105 and incident to the camera unit 102. In response to the camera unit 102 detecting reflective light corresponding to the patterned light, the ISP 103 may create multi-view images based on the patterned light, and may generate a first depth image using the created patterned light-based multi-view images.

The non-patterned light from the external light source 104 may be reflected from the object 105 and incident to the camera unit 102. In response to the camera unit 102 detecting reflective light corresponding to the non-patterned light, the ISP 103 may create multi-view images based on the non-patterned light, and may generate a second depth image using the created non-patterned light-based multi-view images.

The first depth image and the second depth image may be simultaneously generated and obtained.

The “multi-view images” refer to at least two images that are captured from different positions. For example, as in images captured by right and left human eyes, a plurality of images that are obtained at different positions with respect to one object may be referred to as “multi-view images.”

In addition, the “depth image” refers to an image that includes information of a distance to an object. Various methods of generating a depth image containing distance information using multi-view images have been introduced. For example, the ISP 103 may generate the first depth image and the second depth image by applying trigonometry to the multi-view images.

The ISP 103 may perform stereo-matching on the first depth image and the second depth image to generate a third-depth image which may be the final depth image. The stereo-matching will be described in detail later.

As such, the 3D image obtaining apparatus 100 generates the final depth image using both the pattern-based depth image and the non-pattern-based depth image, obtaining a high quality 3D image regardless of the distance to the object.

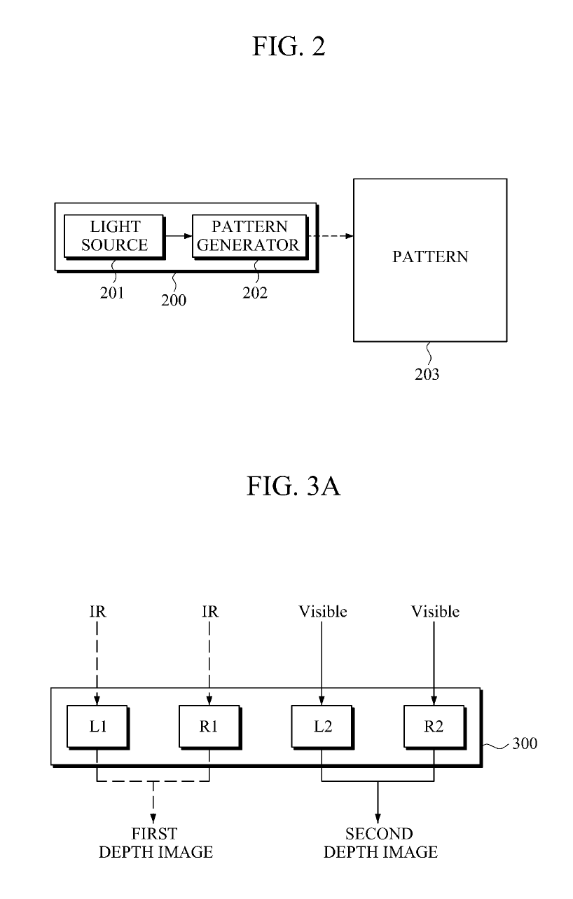

FIG. 2 illustrates an example of a pattern projection unit. Referring to the example illustrated in FIG. 2, the pattern projection unit 200 may include a light source 201 and a pattern generator 202.

The light source 201 may radiate coherent light, such as laser light. For example, the light source 201 may emit infrared light. The light emitted from the light source 201 may be incident to the pattern generator 202.

The pattern generator 202 may generate a random speckle pattern with respect to the incident light. Accordingly, in response to the object 105 being irradiated by the light emitted from the pattern generator 202, a random light pattern 203 may appear on the surface of the object 105.

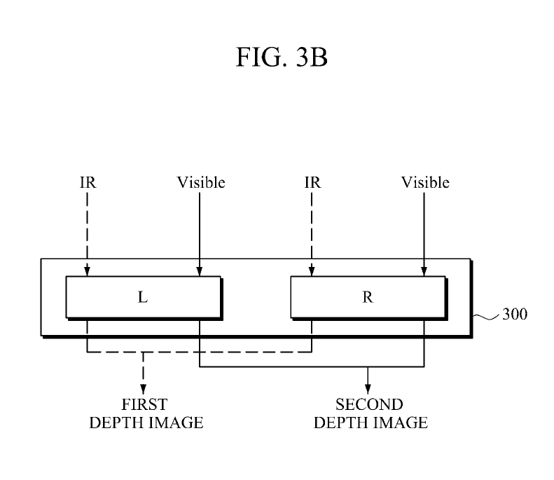

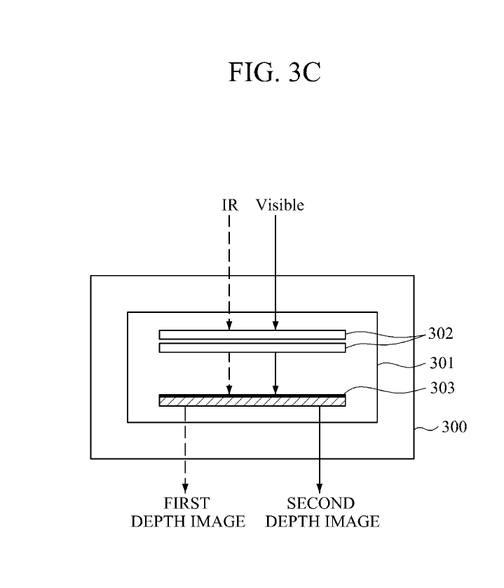

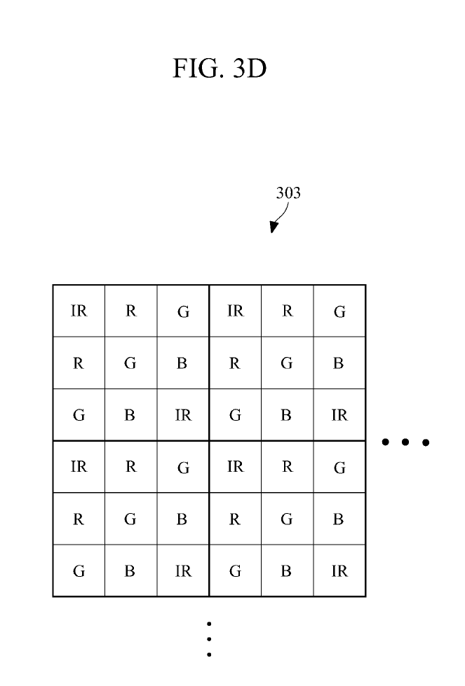

FIGS. 3A to 3D illustrate examples of a camera unit. Referring to the examples illustrated in FIGS. 3A to 3D, the camera unit 300 may include at least one or more camera modules. A camera module may be a lens, a color filter array, or an image sensor. The image sensor may be a solid state imaging device, such as a charge-coupled device (CCD) or a complementary metal-oxide semiconductor (CMOS), which detects light and generates an electric signal corresponding to the detected light. These are nonlimiting examples. In the examples illustrated in FIGS. 3A to 3D, the camera unit 300 may be divided into a region which receives reflective light corresponding to patterned light and a region which receives reflective light corresponding to non-patterned light.

In the example illustrated in FIG. 3A, the camera unit 300 may include four camera modules L1, R1, L2, and R2. Two camera modules L1 and R1 may detect the reflective light corresponding to the patterned light. The reflective light corresponding to the patterned light may be light incident to the camera unit 300, which may have been radiated from the pattern projection unit 101 and reflected by the object 105. For example, the camera modules L1 and R1 may detect infrared light. In one example, the first depth image may be generated based on the infrared light detected by the camera modules L1 and R1. The rest of the camera modules L2 and R2 may detect the reflective light corresponding to the non-patterned light. The reflective light corresponding to the non-patterned light may be light incident to the camera unit 300, which may have been radiated from the external light source 104 and then reflected by the object 104. For example, the camera modules L2 and R2 may detect visible light. In one example, the second depth image may be generated based on the visible light detected by the camera modules L2 and R2.

In the example illustrated in FIG. 3B, the camera unit 300 may include two camera modules L and R. In one example, patterned light-based multi-view images may be obtained using infrared light components detected by the camera modules L and R. In addition, non-pattern-based multi-views may be obtained using visible light components detected by the camera modules L and R. The patterned light-based multi-view images using the infrared light components may be the base for the first depth image, and the non-patterned light-based multi-view images using the visible light components may be the base for the second depth image.

Referring to the example illustrated in FIG. 3C, the camera unit 300 may include a camera module 301. The single camera module 301 may be a light field camera to obtain multi-view images. The light field camera may be configured to have an optical system that may enable the obtaining of multi-view images with a single camera using a plurality of lenses 302 and an appropriate filter 303. The plurality of lenses 302 may adjust focuses of the multi-view images. The filter 303 may divide reflective light based on which type of light the reflective light corresponds to between the patterned light and the non-patterned light. An example of the filter 303 is illustrated in FIG. 3D.

Referring to the example illustrated in FIG. 3D, the filter 303 may include one or more arrays, each including three rows and three columns (hereinafter, referred to as a “3×3 array”). The 3×3 array may include areas to pass infrared light (IR) and areas to pass visible light (red, green, blue, or “RGB”). The arrangement of IR pixels and RGB pixels shown in the example illustrated in FIG. 3D may be varied according to fields of application.

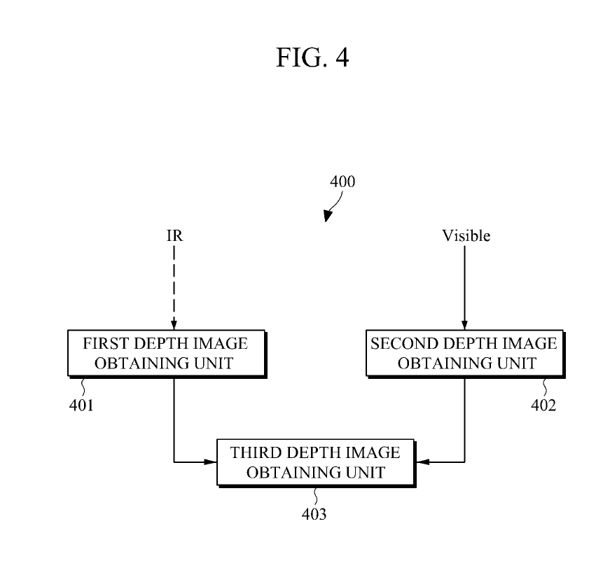

FIG. 4 illustrates an example of an image signal processor (ISP). Referring to the example illustrated in FIG. 4, the ISP 400 may include a first depth image obtaining unit 401, a second depth image obtaining unit 402, and a third depth image obtaining unit 403.

The first depth image obtaining unit 401 may obtain a first depth image based on patterned light. The patterned light may be infrared light or ultraviolet light radiated from a pattern projection unit 101. The patterned light radiated from the pattern projection unit 101 may be reflected by an object 105 and incident to a camera unit 102. The first depth image obtaining unit 401 may obtain a first depth image using multi-view images created based on the patterned light detected by the camera unit 102. For example, in the example illustrated in FIG. 3A, the first depth image obtaining unit 401 may obtain the first depth image based on information of infrared light detected by the camera modules L1 and R2.

The second depth image obtaining unit 402 may obtain a second depth image based on non-patterned light. The non-patterned light may be, for example, light radiated from the external light source 104 shown in the example illustrated in FIG. 1. In the example illustrated in FIG. 4, the non-patterned light may not have any patterns, but may have a different wavelength range from that of the patterned light radiated from the pattern projection unit 101. The second depth image obtaining unit 402 may obtain a second depth image using multi-view images created based on the non-patterned light detected by the camera unit 102. For example, in the example illustrated in FIG. 3A, the second depth image obtaining unit 402 may obtain the second depth image based on information of the visible light detected by the camera modules L2 and R2.

The third depth image obtaining unit 403 may perform stereo-matching on the first depth image and the second depth image to obtain a third depth image.

For example, the third depth image obtaining unit 403 may perform the stereo matching based on an energy-based Markov Random Field (MRF) model, which may be represented as Equation 1 below.

$$\hat{d} = arg {min}_{d} E ( d ) , \\ E ( d ) = {\sum }_{i} {f}_{D} ( {d}_{i} ) + {α}_{1} {\sum }_{i} {f}_{P} ( {d}_{i} ) + {α}_{2} {\sum }_{i , j ∈ N} {f}_{s} ( {d}_{i} , {d}_{j} ) \qquad [ Equation 1 ]$$

For example, “\hat{d}” denotes a distance that makes the MRF model, E(d), the minimum. “dᵢ” denotes a pixel distance. f_{D}(dᵢ) represents a cost function obtained from the second depth is image, fₚ(dᵢ) represents a cost function obtained from the first depth image, and fₛ(dᵢ, dⱼ) represents a constraint cost function of a distance between adjacent pixels.

In Equation 1, f_{D}(dᵢ) may be obtained using multi-view images based on visible light that is non-patterned light, and may be represented as Equation 2 below.

$${f}_{D} ( {d}_{i} ) = {\sum }_{k = 1}^{{N}^{V}} ( {\sum }_{m ∈ R ( i )} W ( m , i ) \vert {I}_{k}^{V} ( m + {h}_{k}^{V} ( {d}_{i} ) ) - {I}_{R}^{V} ( m ) \vert / {\sum }_{m ∈ R ( i )} W ( m , i ) ) , \\ W ( m , i ) = {W}_{spatial} ( m , i ) {W}_{photo} ( m , i ) , \\ {W}_{spatial} ( m , i ) = g ( - \vert m - i \vert ) , \\ {W}_{photo} ( m , i ) = g ( - \vert {I}_{k}^{V} ( m + {h}_{k} ( d ) ) - {I}_{k}^{V} ( i + {h}_{k}^{V} ( d ) ) \vert ) g ( - \vert {I}_{k}^{V} ( m ) - {I}_{R}^{V} ( i ) \vert ) \qquad [ Equation 2 ]$$

For example, “W” represents a bilateral weight. The bilateral weight may be categorized into a spatial weight and a photometric weight. “g” represents a Gaussian function. R(i) represents a group of pixels based on the i^{th} pixel in Window, and the group may have a predetermined size. I_{R}^{V} denotes a reference image, and Iₖ^{V} denotes N^{v} images (where N and V are integrals) which are captured at different positions. In an example in which a three-dimensional position of the ith pixel of the reference image I_{R}^{V} is represented as (X, Y, dᵢ), hₖ^{v} denotes a point of the image Iₖ^{v} which corresponds to the reference position (X, Y, dᵢ). The corresponding point of each image with respect to the reference image I_{R}^{V} may be calculated by obtaining a projection matrix through calibration.

Referring to Equation 1 again, fₚ(dᵢ) may be calculated by Equation 3 below.

$${f}_{P} ( {d}_{i} ) = min ( {a}_{P} \vert {d}_{t} - {d}_{t}^{IR} \vert , {T}_{P} ) \\ {α}_{i} = {\sum }_{m ∈ R ( i )} g ( - \vert m - i \vert ) \vert Δ {I}_{R}^{IR} ( m ) \vert / {\sum }_{m ∈ R ( i )}^{ } g ( - \vert m - i \vert ) \\ {d}_{i}^{IR} = arg {min}_{d} {\sum }_{k = 1}^{{N}^{IR}} ( {\sum }_{m ∈ R ( i )} g ( - \vert m - i \vert ) \vert {I}_{k}^{IR} ( m ) - {I}_{R}^{IR} ( m + {h}_{k}^{IR} ( {d}_{i} ) ) \vert / {\sum }_{m ∈ R ( i )} g ( - \vert m - i \vert ) ) \qquad [ Equation 3 ]$$

For example, fₚ(dᵢ) may be calculated to indicate the entire processing costs required to update the distance value dᵢ^{IR} obtained from patterned light-based multi-view images. αₗ denotes a weighted average of absolute values of gradients of images in R(i). That is, matching costs may be obtained with respect to a pixel having a high differential value, and distance information of a non-pattern based image may be further updated on a pixel having a low differential value. dᵢ^{IR} represents a distance value calculated from the patterned light based multi-view images, and a cost value may be calculated by applying to a spatial filter an absolute difference obtained from a reference image I_{R}^{IR} and an image Iₖ^{IR} captured at a different position.

Referring to Equation 1 again, fₛ(dᵢ, dⱼ) is a cost function that makes a resultant image have a sharp discontinuity on a boundary of the object and at the same time represent a smooth surface of the object. fₛ(dᵢ, dⱼ) may be represented as Equation 4 below.

fₛ(dᵢ,dⱼ)=min(aₛ(dᵢ−dⱼ)²,T_{S}) [Equation 4]

Referring to Equation 4, a portion of the resultant image in which a difference value between pixel distances dᵢ and dⱼ is small may be represented smooth, and a portion in which the difference value is greater than a predetermined value may be truncated by Tₛ, so that sharp depth may be obtained with respect to the boundary of the object in the resultant image.

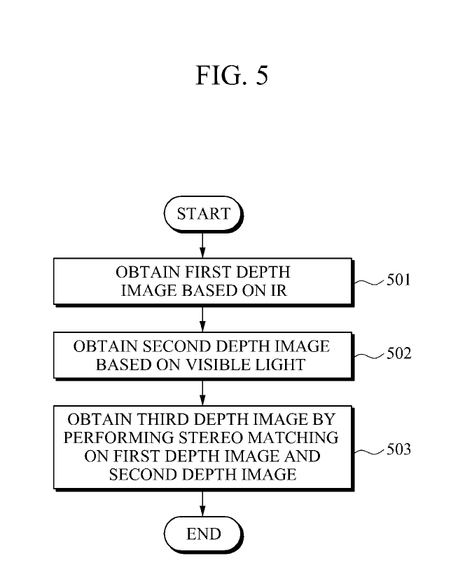

FIG. 5 illustrates a flowchart of an example of a method of obtaining a three-dimensional image. Referring to FIG. 5, in operation 501, a first depth image based on infrared light may be obtained. For example, the pattern projection unit 101 (see FIG. 1) may radiate patterned light of infrared light towards an object, the camera unit 102 (see FIG. 1) may detect infrared light reflected from the object, and the first depth image obtaining unit 401 (see FIG. 4) may generate the first depth image containing an infrared light-based multi-view image and distance information.

In operation 502, a second depth image based on visible light may be obtained. For example, the external light source 104 (see FIG. 1) may radiate visible light without a pattern to the object, the camera unit 102 may detect the visible light reflected from the object, and the second depth image obtaining unit 402 (see FIG. 4) may generate the second depth image containing visible light-based multi-view image and distance information.

In operation 503, stereo matching may be performed on the first depth image and the second depth image to generate a third depth image. For example, the third depth image obtaining unit 403 (see FIG. 4) may perform stereo matching using the energy-based Markov Random Field (MRF) model. Detailed procedures of obtaining the third depth image may be as described above with Equations 1 to 4.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the devices described herein may be incorporated in or used in conjunction with mobile devices such as a cellular phone, a personal digital assistant (PDA), a digital camera, a portable game console, and an MP3 player, a portable/personal multimedia player (PMP), a handheld e-book, a portable tablet and/or laptop PC, a global positioning system (GPS) navigation, and devices such as a desktop PC, a high definition television (HDTV), an optical disc player, a setup and/or set top box, and the like, consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for obtaining a three-dimensional image, the apparatus comprising:
a first depth image obtaining unit configured to obtain a first depth image, based on patterned light;
a second depth image obtaining unit configured to obtain a second depth image, based on non-patterned light that is different from the patterned light; and
a third depth image obtaining unit configured to obtain a third depth image, based on the first depth image and the second depth image.

2. The apparatus of claim 1, wherein the third depth image obtaining unit is further configured to perform stereo matching on the first depth image and the second depth image to obtain the third depth image.

3. The apparatus of claim 2, wherein the third depth image obtaining unit is further configured to perform the stereo matching based on an energy-based Markov Random Field (MRF) model.

4. The apparatus of claim 1, further comprising:
a pattern projection unit configured to project the patterned light onto an object; and
a camera unit configured to detect light reflected from the object.

5. The apparatus of claim 4, wherein the pattern projection unit is further configured to generate the patterned light using infrared light or ultraviolet light.

6. The apparatus of claim 5, wherein the camera unit comprises:
a first sensor unit configured to detect infrared or ultraviolet light, corresponding to the patterned light from the object; and
a second sensor unit configured to detect visible light corresponding to the non-patterned light from the object.

7. The apparatus of claim 1, further comprising a filter configured to divide reflective light based on a type of light to which the reflective light corresponds between the patterned light and the non-patterned light.

8. A method of obtaining a three-dimensional image, the method comprising:
obtaining a first depth image, based on patterned light;
obtaining a second depth image, based on non-patterned light that is different from the patterned light; and
obtaining a third depth image, based on the first depth image and the second depth image.

9. The method of claim 8, wherein the obtaining of the third depth image comprises performing stereo matching on the first depth image and the second depth image.

10. The method of claim 9, wherein, in the obtaining of the third depth image, the performing of the stereo matching is based on an energy-based Markov Random Field (MRF) model.

11. The method of claim 8, wherein the patterned light is based on infrared light or ultraviolet light.

12. The method of claim 8, further comprising dividing, with a filter, reflective light based on a type of light to which the reflective light corresponds between the patterned light and the non-patterned light.

13. A computer-readable information storage medium storing a program for implementing a method of obtaining a three-dimensional image, comprising:
obtaining a first depth image, based on patterned light;
obtaining a second depth image, based on non-patterned light that is different from the patterned light; and
obtaining a third depth image, based on the first depth image and the second depth image.

14. The computer-readable information storage medium of claim 13, wherein the obtaining of the third depth image comprises performing stereo matching on the first depth image and the second depth image.

15. The computer-readable information storage medium of claim 14, wherein, in the obtaining of the third depth image, the performing of the stereo matching is based on an energy-based Markov Random Field (MRF) model.

16. The computer-readable information storage medium of claim 13, wherein the patterned light is based on infrared light or ultraviolet light.

17. The computer-readable information storage medium of claim 13, further comprising dividing reflective light based on a type of light to which the reflective light corresponds between the patterned light and the non-patterned light.
